(19) United States
(12) Patent Application Publication
(10) Pub. No.: US 2010/0011979 A1
(43) Pub. Date: Jan. 21, 2010

(54) DEVICE FOR INSCRIBING IDENTIFICATION PLATES

(75) Inventors: Klaus-Dieter Bier, Leutenbach (DE); Thomas Gangl, Mainhardt (DE); Juergen Schmid, Baltmannsweiler (DE)

Correspondence Address: COLLARD & ROE, P.C., 1077 NORTHERN BOULEVARD, ROSLYN, NY, 11576, US

(73) Assignee: Murrplastik Systemtechnik GmbH

(21) Appl. No.: 12/449,499

(22) PCT Filed: Feb. 13, 2008
(86) PCT No.: PCT/EP2008/051732

§ 371 Date: Aug. 11, 2009

(30) Foreign Application Priority Data
Mar. 6, 2007 (DE) 10 2007 011 179.9

(51) Int. Cl. B41F 1/38

(52) U.S. Cl. 101/407.1

(57) ABSTRACT

The invention relates to a method for inscribing identification plates (22) of an identification plate set (16) having a retaining device (14) in which the identification plate set (16) may be fixed, and having an inscribing unit (18), which comprises a carrier arm (24) movable in a linear fashion in an advancement direction (26) and spanning the retaining device (14) and an inscribing head (20) mounted on the carrier arm (24) such that it is movable transversely to the advancement direction (26) for inscribing the identification plates (22). According to the invention, the inscribing unit (18) has a gripping unit (36) for gripping and transporting the identification plate set (16).

The invention relates to a device for inscribing identification plates of an identification plate set, in accordance with the preamble of claim 1.

Known devices of this type serve for inscribing identification plates by means of an inscription head, which can have a laser printer, a pin plotter, or an engraving device, for example. The identification plates are generally not passed to the inscription device separately, but rather in sets of identification plates, which have a plurality of identification plates that lie in a plane. Such identification plate sets are known, for example, from DE 42 39 434 A1 and PCT/EP 2006/010 932. In the case of known inscription devices, an identification plate set is manually laid into the holding device and fixed in place. The inscription head is moved over the identification plate set fixed in place in a defined position in this manner, by means of the carrier arm, and this head applies the inscription to the identification plate set. In this connection, placement of the identification plate sets into the holding device is complicated and also imprecise, in some cases.

In order to improve the process of laying the identification plate sets into the holding device, a belt drive has already been proposed. The inscription device has belts that run in a base frame and engage into engagement channels on the underside of the identification plate sets, and thus advance the identification plate sets all the way to the holding device, in an advancement direction. However, this solution is technically complicated and therefore expensive.

It is therefore the task of the invention to further develop a device of the type stated initially, in such a manner that it allows easier positioning of the identification plate set.

This task is accomplished, according to the invention, by means of a device having the characteristics of claim 1. Advantageous further developments of the invention are the object of the dependent claims.

The invention is based on the idea that a component that can be moved in the advancement direction of the identification plate set is already present on the inscription device, in the form of the inscription unit, which component can be utilized for advancing the identification plate set to the holding device. If the inscription unit is equipped with a gripping unit, this is merely a simple structural change that can be brought about without great effort. By means of the gripping unit, the possibility is created of automatically passing the identification plate set to the holding device, and this generally allows more precise positioning than manual insertion. Automatic advancement is particularly advantageous if a plurality of identification plate sets is combined into an almost endless strand, as described in PCT/EP 2006/010 932.

It is advantageous if the gripping unit has a transport pin for engagement into a transport hole in the identification plate set. This is a particularly simple possibility for grasping and transporting the identification plate set. The corresponding transport hole can be formed into the identification plate set in simple manner, for example during injection molding. The transport pin can be affixed to the inscription head, or, in particularly advantageous manner, to the carrier arm. It is practical if the transport pin is attached to the inscription head or to the carrier arm in height-adjustable manner. For engagement into the transport hole, it is lowered, and after completion of the advancement process, it is pulled out of the transport hole by simply being raised. For this purpose, it is advantageous if the gripping unit has a drive unit for raising and lowering the transport pin.

Preferably, the transport pin is affixed to the carrier arm by way of a longitudinal center axis of the holding device. Particularly if the identification plate set is symmetrical to this longitudinal center axis, an advantageous force distribution is obtained. According to an advantageous further development, the transport pin has a contact surface for pressing down onto a surface of the identification plate set, as well as a mandrel that extends from the contact surface, for engagement into the hole. In this way, the transport pin can not only transfer forces parallel to the plane in which the identification plates lie, but also perpendicular to this plane. By means of pressing the transport pin onto the identification plate set, it is therefore possible to hold the latter in a defined position, particularly in the holding device.

It is practical if the inscription device has a transport groove for feeding the identification plate set to the holding device, which groove has a bottom for laying down a central carrier of the identification plate set, and side walls that extend upward from the bottom. The identification plates are formed onto the central carrier, directly or by way of side carriers that extend to the side. This measure, with which particularly precise feed of the identification plate set to the holding device is made possible, in that slipping crosswise to the advancement direction is avoided, to a great extent, can also be used independent of the use of the gripping unit. The central carrier of the identification plate set, particularly as in PCT/EP 2006/010 932, the disclosure content of which, relating to the description of the identification plate set, is hereby to be integrated into the present application, rests on the bottom of the groove, while the side carriers that carry the identification plates project laterally beyond the groove. For this purpose, the side carriers must be structured to be thinner than the central carrier by at least the height of the side walls.

It is advantageous if the transport groove narrows in the region of the holding device. It preferably narrows to a width, measured between the side walls, that corresponds to the width of the central carrier. In this way, particularly precise positioning of the identification plate set in the holding device is achieved. It is practical if the transport groove is narrowed over a length that is at most equal to the length of the central carrier. This is particularly advantageous if the identification plate set is part of an endless strand: then, only one central carrier is situated in the narrowed region over its full length, in which region the greater friction that increases the advancement force that is required due to the contact on the side walls occurs. In order to facilitate introduction of the central carrier, the bottom has sections that incline downward, relative to the horizontal, toward the ends of the transport groove.

It is advantageous if the holding device has a contact plane for planar contact of the identification plate set. If the identification plate set is laid down in planar manner, it can be fixed in place more precisely. In this connection, it is preferred if the contact plane extends on both sides of the transport groove. In this way, the contact plane is divided in two by the transport groove.

According to an advantageous embodiment, the holding device has a hold-down device for fixing the identification plate set in place. This device serves for precise positioning of the identification plate set in the holding device during the inscription process, if applicable in interaction with the transport pin. In this connection, it is preferred that the hold-down device has at least two holding elements for engagement on the top of the identification plate set, which elements are disposed on different sides of the longitudinal center axis of the holding device. If an identification plate set according to PCT/EP 2006/010 932 is used, then it is advantageous if the two holding elements engage on the lateral projections of the side carriers.

According to a first alternative embodiment, the holding elements are adjustable in height. It is practical if they have at least one positioning pin, in each instance, for engagement into a positioning hole in the identification plate set. Once the identification plate set has been pushed into the holding device, the holding elements are lowered for fixation. Alternatively or in addition, the holding elements can be movable horizontally. For engagement over the top of the identification plate set, they are moved up to the latter from the side, and lowered onto it, if necessary.

According to a second alternative embodiment, the holding elements are fixed in place, and the hold-down device has a lifting unit for lifting the identification plate set and pressing it against the holding elements. In this connection, it is preferred that the lifting unit has at least one positioning pin for engagement into a positioning hole in the identification plate set. It is practical if the lifting unit has at least one plate for planar contact on the underside of the identification plate set. The plate then forms the contact plane of the holding device. It is particularly preferred that the lifting unit has a drive device that is accommodated in a housing, that the housing has at least one opening for passing the plate through, and that the opening is covered by an elastic film. Dust that occurs during inscription of the identification plates, particularly during engraving, then cannot penetrate into the housing and impair the function of the lifting unit.

In the following, the invention will be explained in greater detail, using an exemplary embodiment shown in the drawing. This shows:

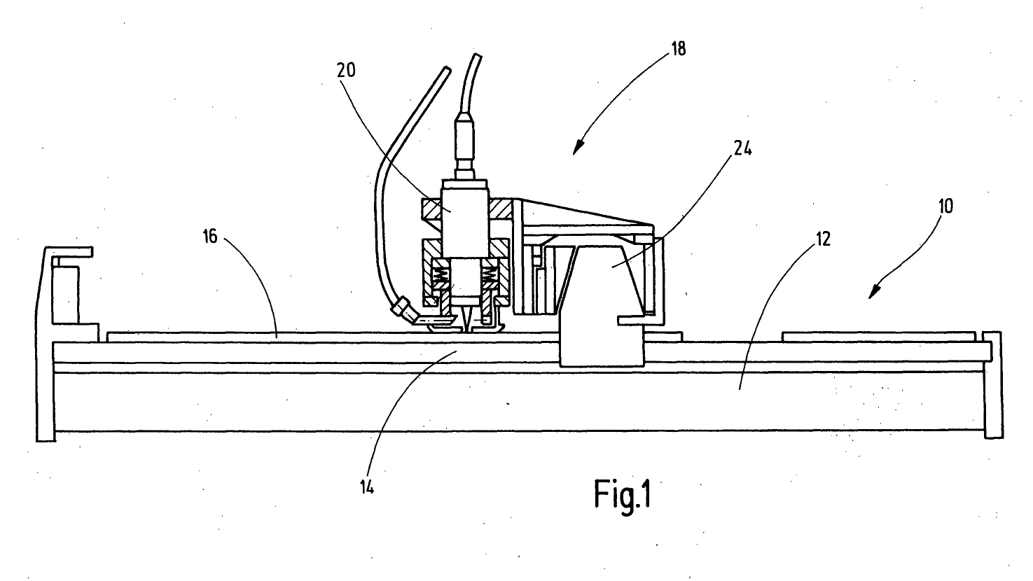

FIG. 1 a schematic representation of an inscription device in a side view;

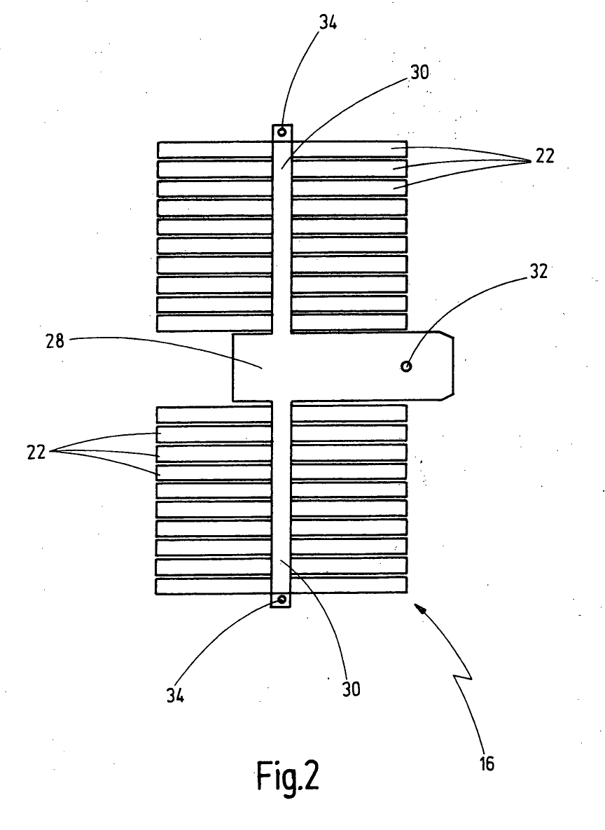

FIG. 2 an identification plate set in a top view;

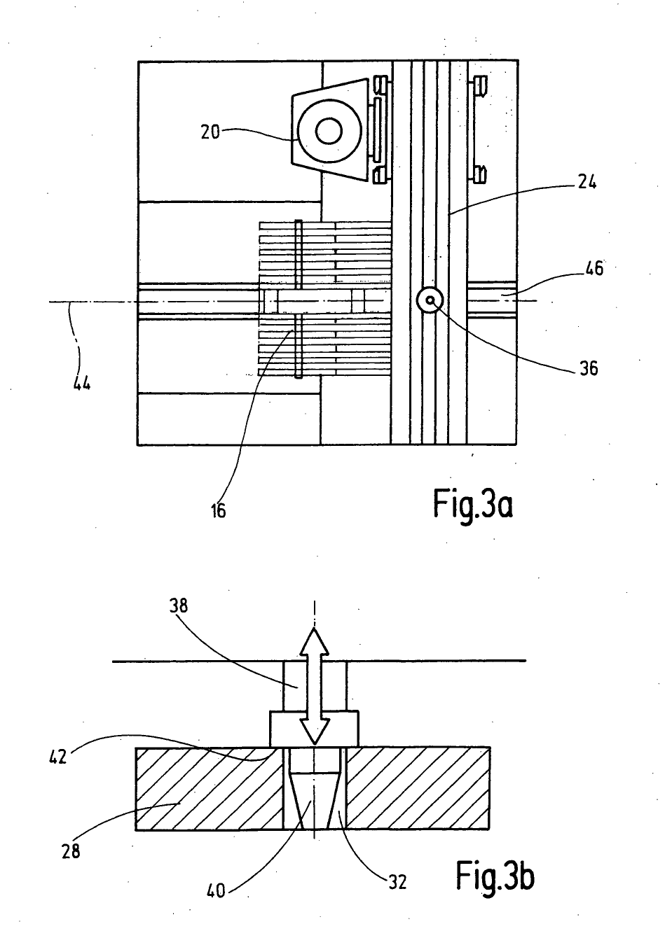

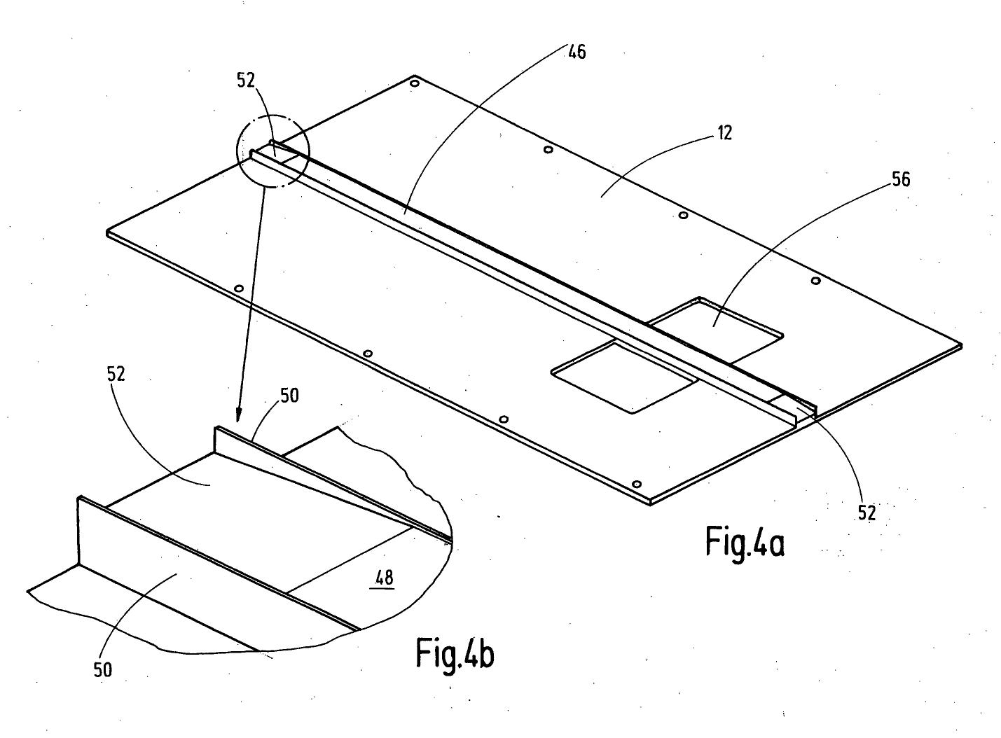

FIG. 3a, 3b schematic representations of a gripping unit of the device according to FIG. 1;

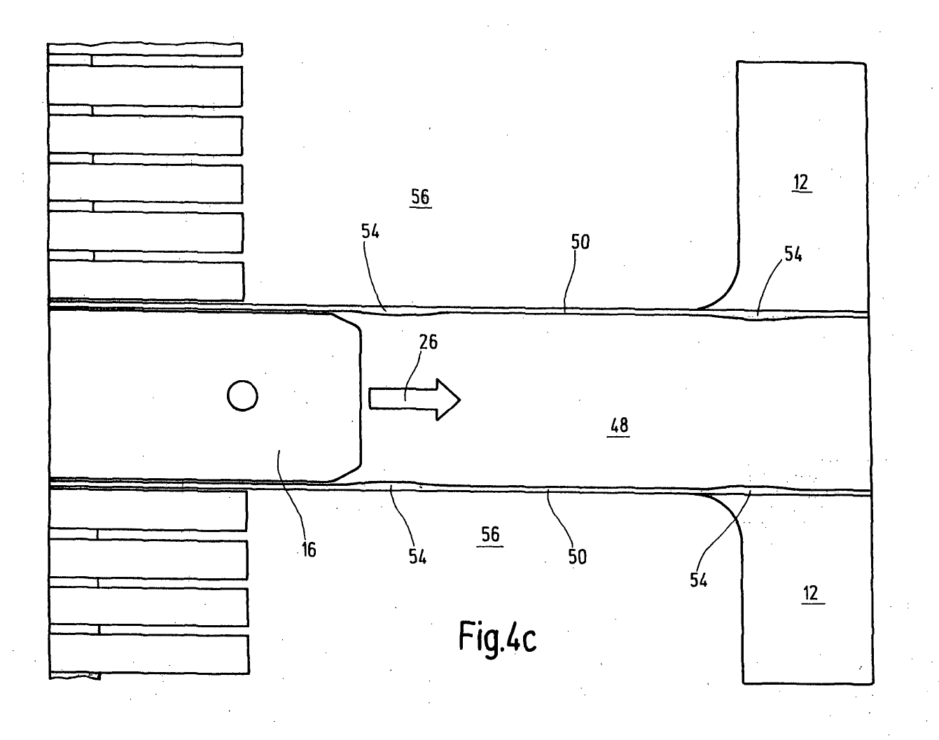

FIG. 4a to 4c a schematic representation of a transport groove of the device according to FIG. 1 in an overall representation and two detail representations, and

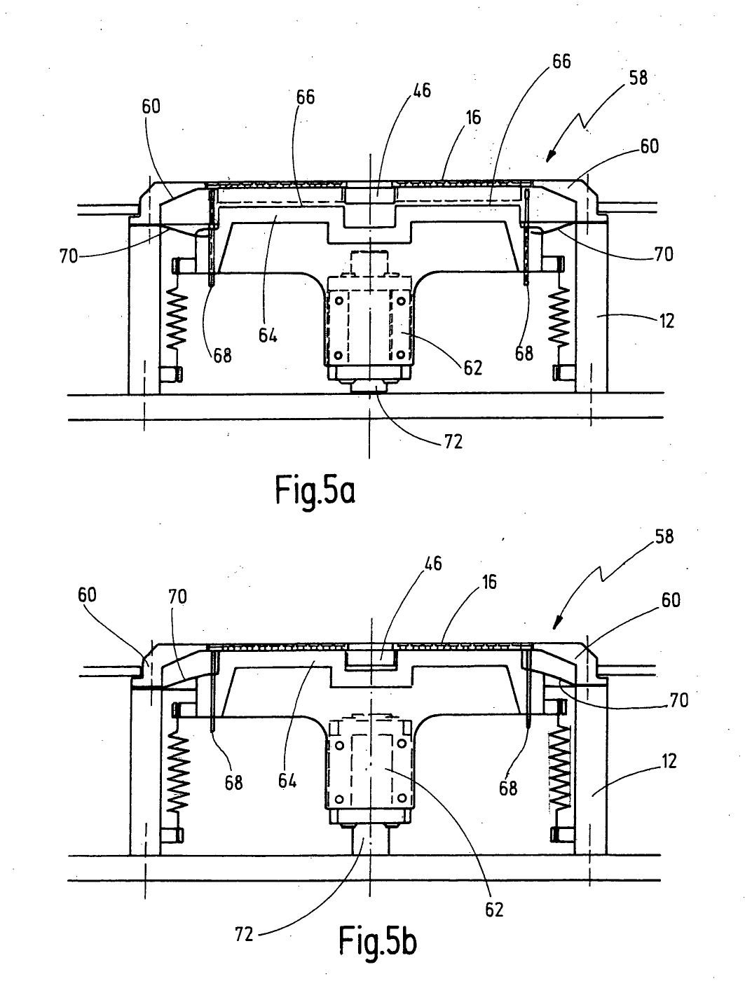

FIG. 5a, 5b a schematic representation of a holding device of the device according to FIG. 1.

An inscription device 10 (FIG. 1) has a base frame 12 having a holding device 14, which serves to fix a set of identification plates 16 in place in a predetermined position. An inscription unit 18 is movably disposed above the holding device 14 and has an inscription head 20 for inscribing the identification plates 22. In the exemplary embodiment shown, the inscription head 20 is part of a laser printer. However, it can easily be replaced by another inscription head having a pin plotter or an engraving device, for example. The inscription head 20 is affixed to a carrier arm 24 that is mounted on the base frame 12 so as to be displaceable, in linear manner, in the advancement direction 26. The inscription head 20 is mounted on the carrier arm 24 so as to move in a direction crosswise to the advancement direction 26.

A typical identification plate set 26, whose identification plates 22 are supposed to be inscribed by the inscription device 10, is shown in FIG. 2. It has a central carrier 28 as well as side carriers 30 that extend laterally from the central carrier 28, onto which the identification plates 22 are formed. The central carrier 28 has a transport hole 32 in its longitudinal center axis, while the side carriers 30 have a positioning hole 34 at their free ends, in each instance. For use in the inscription device 10, identification plate sets 16 can be used essentially as an endless strand, particularly linked together in the longitudinal direction, as described in PCT/EP 2006/010 932.

In order to feed the identification plate sets 16 to the holding device 14 by machine, the inscription unit 18 has a gripping unit 36 for grasping an identification plate set 16 (FIG. 3a, 3b). This device has a transport pin 38 that is adjustable in height and can be lowered by means of a drive unit, and is attached to the transport arm 24, the free lower end of which pin forms a mandrel 40 for engagement into the transport hole 32. Above the mandrel 40, the transport pin 38 has a circumferential ring whose underside forms a contact surface 42 that comes to rest on the surface of the identification plate set 16 when the transport pin 38 is lowered onto the latter. The transport pin 38 is disposed above the longitudinal center axis 44 of the inscription device 10, with which the longitudinal center axis of the identification plate set 16 coincides when the latter is situated in the holding device 40.

A transport groove 46 is attached to the base frame 12 that forms a housing (FIG. 4a to 4c), which groove has a bottom 48 and side walls 50 that extend upward from the bottom 48. The depth of the transport groove 46, defined by the height of the side walls 50, is dimensioned in such a manner that the central carrier 28 can rest on the bottom 48, while the side carriers 30 project laterally beyond the side walls 50. The longitudinal center axis 44 of the inscription device is defined by the longitudinal center axis of the transport groove 46, even if the transport groove 46, in contrast to what is shown in FIG. 4a, is disposed outside of the center. The width of the transport groove 46, defined by the spacing of the side walls 50, is slightly greater than the width of the central carrier 28, so that on the one hand, the position of the identification plate set 16 is already established in fairly precise manner, but on the other hand, advancement is possible with little friction. At its ends, the transport groove 46 has insertion bevels 52, where the bottom 48 is inclined downward, relative to the horizontal, toward the end. In the region of the holding device 14, the transport groove 46 is narrowed at two points, the distance between which points, in the advancement direction 26, is less than the length of the central carrier 28. These narrowed parts 54 allow precise positioning of the identification plate set 16 in the direction perpendicular to the advancement direction 26.

In the region of the holding device 14, the housing 12 has an opening 56 in its ceiling (FIG. 4a). In this region, a hold-down device 58 that serves to fix the identification plate set 16 in place is disposed. The hold-down device 58 has two holding elements 60 affixed on the base frame 12 in a fixed location. These elements are configured in rail shape, and run parallel at a distance from the side walls 50. The free ends of the side carriers 30 are pushed under the holding elements 60. At their ends, the holding elements 60 are bent upward a piece, in order to facilitate engagement with the identification plate set 16 during advancement. There is a lifting unit 62 in the base frame 12, which has a table 64 that can be displaced in the vertical direction by means of a spindle 72. This table has a two-part divided contact plane 66, which is brought up to the identification plate set 16 from the bottom, on both sides of the transport groove 46, until the set is fixed in place between the table 64 and the holding elements 60. Furthermore, the lifting unit 62 has two positioning pins 68, which engage into the positioning holes 34 in order to achieve precise positioning of the identification plate set 16 in the holding device 14. An elastic film 70 made of latex is affixed between the table 64 and the base frame 12, which film seals the opening 56, so that no dust can penetrate into the interior of the base frame 12.

An inscription process takes place as follows: first, an identification plate set 16 is laid onto the transport groove 46 by hand. This can be an individual identification plate set 16 or an identification plate set connected with other identification plate sets to form an endless strand. The carrier arm 24 moves to the location where the identification plate set 16 was laid down. Then, the transport pin 38 is lowered until it engages into the transport hole 32. The identification plate set 16 is transported in the advancement direction 26 to the holding device 14, by means of linear displacement of the carrier arm, where it is fixed in place by means of the hold-down device 58. Once the identification plate set 16 has been fixed in place, the transport pin 38 is raised out of the transport hole 32, and the inscription process by means of the inscription head 20 begins.

During the inscription process, the inscription head 20 is moved crosswise to the advancement direction 26, for one thing, and for another, it is moved in the advancement direction by means of a movement of the carrier arm 24. After the inscription process has been completed, the identification plate set 16 is released by means of lowering of the lifting unit 62. If this is an individual identification plate set 16, the transport pin 38 engages into the transport hole 32 once again and transports the identification plate set 16 in the advancement direction 26, out of the region of the holding device 14, until it can be removed from the transport groove 46 by hand. If the identification plate set 16 is part of a strand, then the carrier arm 24 moves into a position in which the transport pin 38 can engage into the transport hole 32 of a subsequent identification plate set 16.

In summary, the following should be stated:

The invention relates to a device for inscribing identification plates 22 of an identification plate set 16, having a holding device 14 in which the identification plate set 16 can be fixed in place, and having an inscription unit 18 that has a carrier arm 24 that spans the holding device 14, which arm can be moved, in linear manner, in an advancement direction 26, and an inscription head 20 for inscribing the identification plates 22, which head is mounted to move crosswise to the advancement direction 26, on the carrier arm 24. According to the invention, it is provided that the inscription unit 18 has a gripping unit for grasping and transporting the identification plate set 16.

1. Device for inscribing identification plates (22) of an identification plate set (16), having a holding device (14) in which the identification plate set (16) can be fixed in place, and having an inscription unit (18) that has a carrier arm (24) that spans the holding device (14), which arm can be moved, in linear manner, in an advancement direction (26), and an inscription head (20) for inscribing the identification plates (22), which head is mounted to move crosswise to the advancement direction (26), on the carrier arm (24), wherein the inscription unit (18) has a gripping unit (36) for grasping and transporting the identification plate set (16).

2. Device according to claim 1, wherein the gripping unit (36) has a transport pin (38) on the inscription head (20) or on the transport arm (24) for engagement into a transport hole (32) in the identification plate set (16).

3. Device according to claim 2, wherein the transport pin (38) is attached to the inscription head (20) or to the carrier arm (24) in height-adjustable manner.

4. Device according to claim 3, wherein the gripping unit (36) has a drive unit for raising and lowering the transport pin (38).

5. Device according to claim 2, wherein the transport pin (38) is affixed to the carrier arm (24) above a longitudinal center axis (44) of the holding device (14).

6. Device according to claim 2, wherein the transport pin (38) has a contact surface (42) for pressing down onto a surface of the identification plate set (16), as well as a mandrel (40) that extends from the contact surface (42), for engagement into the transport hole (32).

7. Device according to claim 1, further comprising a transport groove (46) for feeding the identification plate set (16) to the holding device (14), which groove has a bottom (48) for laying down a central carrier (28) of the identification plate set (16) that carries the identification plates (22), and side walls (50) that extend upward from the bottom (48).

8. Device for inscribing identification plates (22) of an identification plate set (16), having a holding device (14) in which the identification plate set (16) can be fixed in place, and having an inscription unit (18) that has a carrier arm (24) that spans the holding device (14), which arm can be moved, in linear manner, in an advancement direction (26), and an inscription head (20) for inscribing the identification plates (22), which head is mounted to move crosswise to the advancement direction (26), on the carrier arm (24), further comprising a transport groove (46) for feeding the identification plate set (16) to the holding device (14), which groove has a bottom (48) for laying down a central carrier (28) of the identification plate set (16) that carries the identification plates (22), and side walls (50) that extend upward from the bottom (48).

9. Device according to claim 7, wherein the transport groove (46) narrows in the region of the holding device (14), preferably to a width, measured between the side walls (50), that corresponds to the width of the central carrier (28).

10. Device according to claim 9, wherein the transport groove (46) is narrowed over a length that is at most equal to the length of the central carrier (28).

11. Device according to claim 7, wherein the bottom (48) has sections (52) that incline downward, relative to the horizontal, toward the ends of the transport groove (46).

12. Device according to claim 1, wherein the holding device (14) has a contact plane (66) for planar contact of the identification plate set (16).

13. Device according to claim 7, wherein the contact plane (66) extends on both sides of the transport groove (46).

14. Device according to claim 1, wherein the holding device (14) has a hold-down device (58) for fixing the identification plate set (16) in place.

15. Device according to claim 14, wherein the hold-down device (58) has at least two holding elements (60) for engagement on the top of the identification plate set (16), which elements are disposed on different sides of a longitudinal center axis (44) of the holding device (14).

16. Device according to claim 14, wherein the holding elements (60) are adjustable in height.

17. Device according to claim 16, wherein the holding elements (60) have at least one positioning pin for engagement into a positioning hole (34) in the identification plate set (16) in each instance.

18. Device according to claim 14, wherein the holding elements can be moved horizontally.

19. Device according to claim 14, wherein the holding elements (60) are fixed in place, and that the hold-down device (58) has a lifting unit (62) for lifting the identification plate set (16) and pressing it against the holding elements (60).

20. Device according to claim 19, wherein the lifting unit (62) has at least one positioning pin (68) for engagement into a positioning hole (34) in the identification plate set (16).

21. Device according to claim 19, wherein the lifting unit (62) has at least one plate (64) for planar contact on the underside of the identification plate set (16).

22. Device according to claim 21, wherein the lifting unit (62) has a drive device (72) that is accommodated in a housing (12), that the housing (12) has at least one opening (56) for passing the plate (64) through, and that the opening (56) is covered by an elastic film (70).
